(19) United States
(12) Patent Application Publication
(10) Pub. No.: US 2002/0159392 A1
(43) Pub. Date: Oct. 31, 2002

(54) Simplified ATM ring protection for access networks

(75) Inventors: Joshua Klipper, Netanya (IL); Gideon Agmon, Kfar Saba (IL); Ronit Bensky, Hod Hasharon (IL)

Correspondence Address: Fogg, slifer & Polglaze, P.A., P.O. Box 581009, Minneapolis, MN, 55458-1009, US

(73) Assignee: ADC Telecommunications Israel Ltd.

(21) Appl. No.: 09/843,363

(22) Filed: Apr. 25, 2001

(51) Int. Cl. H04J 3/02; G06F 11/00

(52) U.S. Cl. 370/242; 370/539

(57) ABSTRACT

A method of ring protection is provided. The method includes feeding traffic on two transmission rings at a head end node and summing all traffic received on the transmission rings at the head end node. When a facility failure is detected, by a remote node, on one of the two transmission rings, transmitting forward alarm signals on the one transmission ring and return alarm signals on the other transmission ring and globally selecting the one transmission ring to transmit traffic and the other transmission ring to receive traffic from the head end node. When a remote node receives a forward alarm signal, the remote node passes the forward alarm signal on the transmission ring on which the forward alarm signal was received and globally selects the transmission ring on which the forward alarm signal was received to transmit traffic and the other transmission ring to receive traffic from the head end node.

### TECHNICAL FIELD

The present invention relates generally to the field of telecommunications and in particular, to ring protection for wide area networks.

### BACKGROUND

Modem telecommunications networks demand high availability to guarantee minimal down time for end users who rely on these networks for private and/or business usage. To enable such high availability, protection mechanisms are generally supported which enable continued operation even in the event of equipment or facility failures. Equipment protection generally includes the duplication of common system hardware such that a protection card can “take over” operation of a failed card. In linear systems, facility protection may or may not also require duplicated hardware, but usually involves one of the following schemes.

A first point-to-point protection-switching scheme includes duplication of traffic at the transmitting end (source) and the selection of one of the two signals at the receiving end (sink) based on alarm or error status on both received signals. One traffic path is the working path and the second traffic path is a protection path. While a protection protocol may also be used for reporting, it is not required for the protection switching. An example of such a scheme is 1+1 unidirectional switching or unidirectional path protection switching.

A second point-to-point protection-switching scheme includes a protocol between the source and sink to enable the sink to signal back to the source that a facility failure was detected, and an alternate path or facility should be used for transmission. An example of such a scheme is 1+1 bi-directional switching or 1:n switching.

Simple point-to-point facility protection schemes are widely available and have been included in transmission equipment for over 20 years. With the introduction of SONET/SDH equipment and its use in ring topologies over the last 10 years, other SONET/SDH ring protection schemes have been standardized and are widely available from SONET/SDH Add Drop Multiplexer (ADM) vendors. Such schemes include 2 or 4 fiber rings, and are generally characterized as either unidirectional or bi-directional ring.

Unlike the point-to-point protection schemes, ring protection must support traffic that is dropped at a node on the ring, as well as traffic that is passed through to a different node. Fundamentally, using the hierarchical structured format of SONET/SDH frames supports this. For example, for a simple SONET/SDH OC-3 ring, where any node can add/drop any number of virtual tributaries/containers (VT/VC), the SONETISDH ring protection schemes allow each node to protect just the VT/VC's handled at that node, while the remaining VT/VC's are passed through unchanged.

The SONET/SDH ring protection schemes currently defined in standards provide a variety of options, some of the schemes provide quicker switching times and others are optimized for better bandwidth utilization. One fundamental aspect of all the schemes is that the protection scheme is implemented at that level at which the traffic is added/dropped at the node; e.g. if the nodes along the ring add/drop VT/VC's, then the protection scheme is implemented at the VT/VC level. If the nodes along the ring add/drop STS-3/STM-1, then protection is implemented at the STS-3/STM-1 level.

For example, in a ring network having a head end node (node 1) and three slave nodes (nodes 2-4) that are sequentially numbered in the counter clockwise direction. Each of the slave nodes (2-4) adds/drops VT/VC'S. Node 1 selects all of the traffic from either a first port that receives traffic from the clockwise direction or a second port that receives traffic from the counterclockwise direction. If a facility failure occurs between nodes 2 and 3, then node 1 can not use a protection scheme which operates at an STS3/STM-1 level since it will have to select VT/VC's coming from node 2 from the STS3/STM-1 on the clockwise facility and select VT/VC's coming from nodes 3 and 4 from the STS-3/STM-1 on the counter clockwise facility. If node 1 would have to select as a whole, either STS-3/STM-1 at the first port or at the second port, then either node 2 or nodes 3 and 4 would be dropped as a result of the facility failure.

For transport of asynchronous transfer mode (ATM) over synchronous optical network/synchronous digital hierarchy (SONET/SDH) rings, the protection schemes are conceptually the same as those described above. Since nodes add/drop traffic at the ATM level, SONET/SDH level protection is not enough for the same reason described above for which STS-3/STM-1 level protection is not enough for VT/VC level traffic.

Standard schemes based on dual-feeding ATM cells as the source, generally provide the fastest switching time since no rerouting of data is required. However such schemes require double the ATM processing capability to monitor for ATM alarms on the dual-fed connections. In contrast, schemes which do not dual feed ATM cells at the source, but rather use a protocol (e.g. as in 1:n Automatic Protection Switching) to enable the sink to signal to the source to reroute the traffic are generally slower, but do not require double the bandwidth or processing capability (or alternatively enable the extra bandwidth to be used for unprotected traffic).

For the reasons stated above, and for other reasons stated below which will become apparent to those skilled in the art upon reading and understanding the present specification, there is a need in the art for improvements in ring protection in wide area networks.

### SUMMARY

The above mentioned problems with protection schemes in wide area networks and other problems are addressed by embodiments of the present invention and will be understood by reading and studying the following specification.

In one embodiment, a method of ring protection in a network having a first and a second transmission ring is provided. The method includes transmitting traffic to a plurality of remote nodes via the first and second transmission rings and globally selecting the first and second transmission rings to transmit and receive traffic based on alarm signals generated in the network.

In another embodiment, a method of ring protection is provided. The method includes feeding traffic on two transmission rings at a head end node and summing all traffic received on the transmission rings at the head end node. When a facility failure is detected, by a remote node, on one of the two transmission rings, transmitting forward alarm signals on the one transmission ring and return alarm signals on the other transmission ring and globally selecting the one transmission ring to transmit traffic and the other transmission ring to receive traffic from the head end node. When a remote node receives a forward alarm signal, the remote node passes the forward alarm signal on the transmission ring on which the forward alarm signal was received and globally selects the transmission ring on which the forward alarm signal was received to transmit traffic and the other transmission ring to receive traffic from the head end node.

### BRIEF DESCRIPTION OF THE DRAWINGS

FIG. 1 is a block diagram of one embodiment of a network employing ring protection according to the teachings of this invention.

FIG. 2 is an example of a failure in the network of FIG. 1 and an embodiment of ring protection according to the teachings of this invention.

FIG. 3 is another example of a failure in the network of FIG. 1 and an embodiment of ring protection according to the teachings of this invention.

FIG. 4 is a flow chart of an embodiment of a process for selecting transmission rings at a remote node in a ring network according to the teachings of this invention.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

What is needed is protection for ring level failures that affect an entire ring. For example SONET/SDH level failure affecting the container transporting the ATM or an ATM processing card hardware failure affecting all connections terminated at any node.

Embodiments of the current invention provide a simplified protection scheme for ring topologies. In one embodiment, the protection scheme is applied to ATM on SDHISONET ring topologies where traffic flow is to/from a head end node from/to remote nodes. In one embodiment, the protection scheme is applied to an access network, a metropolitan network or the like. In one embodiment, the access network is an asynchronous digital subscriber line (ADSL) access network, an xDSL access network or other broadband access network.

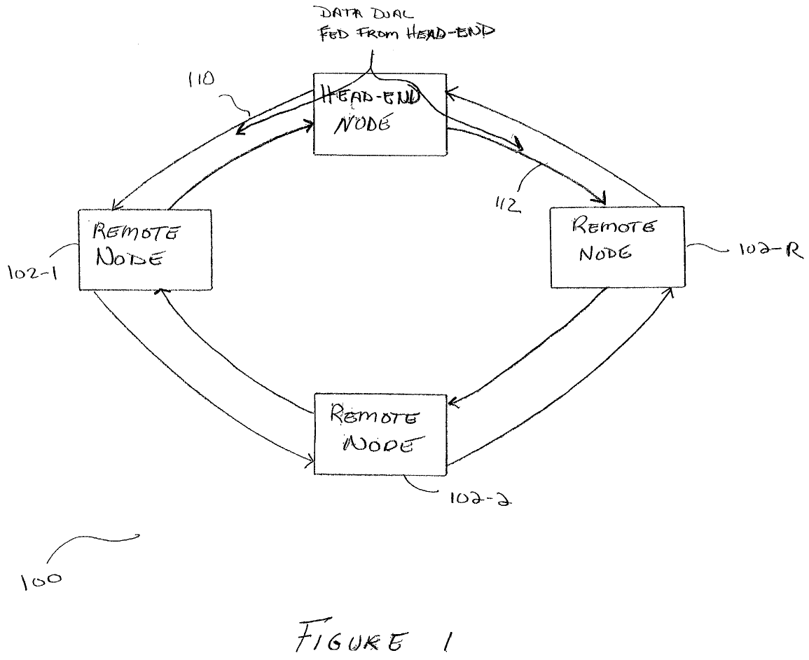

FIG. 1 is a block diagram of an exemplary communication system shown generally at 100 and employs an embodiment of the protection scheme according to the teachings of the present invention. Communication system 100 includes a head end node 104 and a plurality of remote nodes 102-1 to 102-R. In one embodiment, head end node 104 is a central unit and remote nodes 102-1 to 102-R are remote units. The head end node 104 and the remote nodes 102-1 to 102-R are interconnected via first and second transmission rings 110 and 112. Head end node 104 dual feeds traffic to remote nodes 102-1 to 102-R via transmission rings 110 and 112. Each remote node 102-1 to 102-R selects either transmission ring 110 or 112 to accept traffic on. The remote nodes 102-1 to 102-R select a transmission ring 110 or 112 based on alarm, failure and/or error signals on transmission rings 110 and 112. Each remote node 102-1 to 102-R transmits traffic on either transmission ring 110 or 112 that is not necessarily the same transmission ring 110 or 112 as the other remote nodes 102-1 to 102-R transmit traffic.

In this embodiment, remote nodes 102-1 to 102-R do not dual feed traffic. Rather, each remote unit 102-1 to 102-R globally selects one of transmission rings 110 or 112 to transmit traffic on. Head end node 104 sums the traffic received on both rings 110 and 112 for further configuration, transmission or the like. Since each remote node 102-1 to 102-R transmits traffic on only one of the transmission rings 110 or 112, head end node 104 does not have to perform any traffic management with respect to the traffic received from the remote nodes 102-1 to 102-R. If due to a failure, some of the remote nodes 102-1 to 102-R switch transmission from one of transmission ring 110 and 112 to the other, head end node 104 continues to simply combine traffic from both transmission rings 110 and 112 without regard to the switch performed by a remote node 102-1 to 102-R.

In operation, head end node 104 dual feeds traffic on first and second transmission rings 110 and 112, respectively. Remote nodes 102-1 to 102-R each select either the first or second transmission rings 110 or 112 to receive traffic from head end node 104. Each remote node 102-1 to 102-R transmits on either the first or second transmission rings 110 or 112. All traffic received at head end node 104 is summed.

When a failure occurs failure alarm signals such as ring level alarms are generated and transmitted. Any remote nodes 102-1 to 102-R that detect a failure or receive failure alarms responds by inserting forward alarm signals on the transmission line 110 or 112 on which the failure is detected or a failure alarm is received and return alarm signals on the other transmission line 110 or 112. In one embodiment, the adding/dropping of traffic at each remote node 102-1 to 102-R is based on failure and alarm signals received. When there are no alarms on transmission lines 110 or 112, the selection of rings for transmit and receive by remote nodes 102-1 to 102-R is arbitrary.

There is no change at the head end node 104 when a failure occurs, the head end node 104 continues to sum all traffic received. In this embodiment, any alarms that are transmitted terminate at head end node 104. Pass-through traffic for each ring is always passed through transparently for each ring and independent of the alarm states.

It is understood that although FIG. 1 shows only 102-1 to 102-R remote nodes that communication system 100 may include any number of remote nodes 102.

The selection of transmission rings 110 and 112 to transmit or receive (add/drop) traffic on is at the ring level. For example in an access network the selection is done at the ring level versus the ATM level that may include up to a few thousand virtual path circuits.

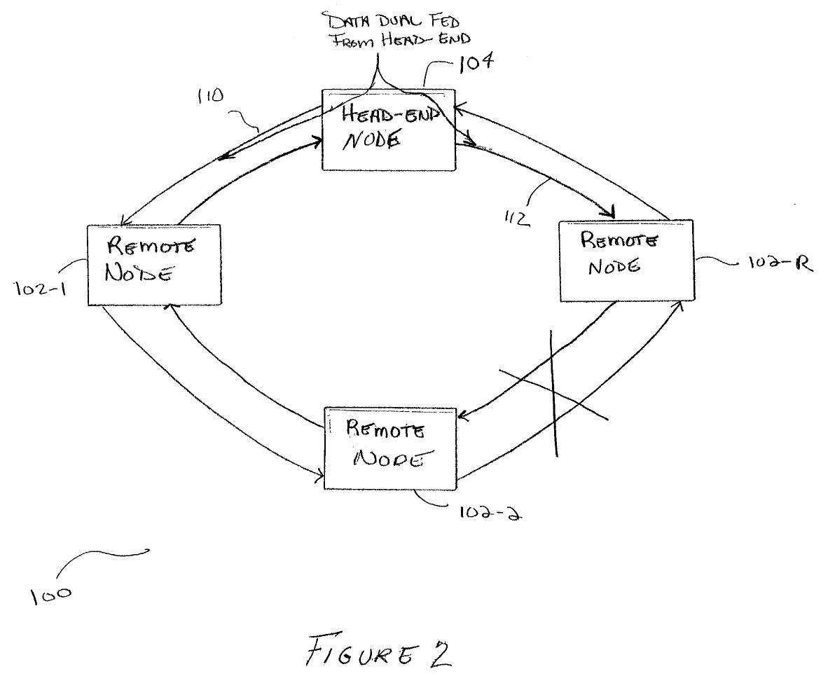

In one example, a failure occurs on the facility between remote nodes 102-2 and 102-R that affects both transmission rings 110 and 112 as shown in FIG. 2. Head end node 104 continues to feed traffic on both transmission rings 110 and 112. Each remote node 102-1 to 102-R monitors the network for failure or alarm signals. In this example, remote node 102-2 detects the failure on transmission ring 112 and inserts forward alarm signals on transmission ring 112 and return alarm signals on transmission ring 110. In one embodiment, remote node 102-2 detects the failure on transmission ring 112 by detecting or receiving ring level alarm signals. Remote node 102-R detects the failure on transmission ring 110 and inserts forward alarm signals on transmission ring 110 and return alarm signals on transmission ring 112. In one embodiment, remote node 102-R detects the failure on transmission ring 110 by detecting or receiving ring level alarm signals. When the facility failure affects both the first and second transmission rings 110 and 112 no nodes see the return alarm signals sent by remote nodes 102-2 and 102-R.

In one embodiment, the forward and return alarm signals are implemented as standard ATM level operation, administration and maintenance (OAM) cells on a single ATM connection between the head end node 104 and each remote node 102-1 to 102-R. In an alternate embodiment, the forward and return alarm signals are SONET/SDH level signals carried over the DCC or user defined overhead bytes.

When remote node 102-2 detects a failure on transmission ring 112, remote node 102-2 will select transmission ring 110 to receive traffic from head end node 104 and transmission ring 112 to transmit traffic to head end node 104. In one embodiment, remote node 102-2 detects a failure on transmission ring 112 by detecting or receiving ring level alarm signals. When remote node 102-1 receives forward alarm signals transmitted by remote node 102-2, remote node 102-1 will select transmission ring 110 to receive traffic from head end node 104 and transmission ring 112 to transmit traffic to head end node 104. When remote node 102-R detects a failure on transmission ring 110, remote node 102-R will select transmission ring 112 to receive traffic from head end node 104 and transmission ring 110 to transmit traffic to head end node 104. In one embodiment, remote node 102-R detects a failure on transmission ring 110 by detecting or receiving ring level alarm signals. Each remote node 102-1 to 102-R that receives forward or return alarm signals forwards the signal(s) along the transmission path 110 and/or 112 that it was received on. Once the alarm signals reach head end node 104 they are terminated. In another embodiment, remote nodes 102-1 to 102-R determine which transmission line 110 or 112 to transmit and receive traffic based on forward and return alarm signals as well as alarm, failure and/or error signals, transmission parameters and the like.

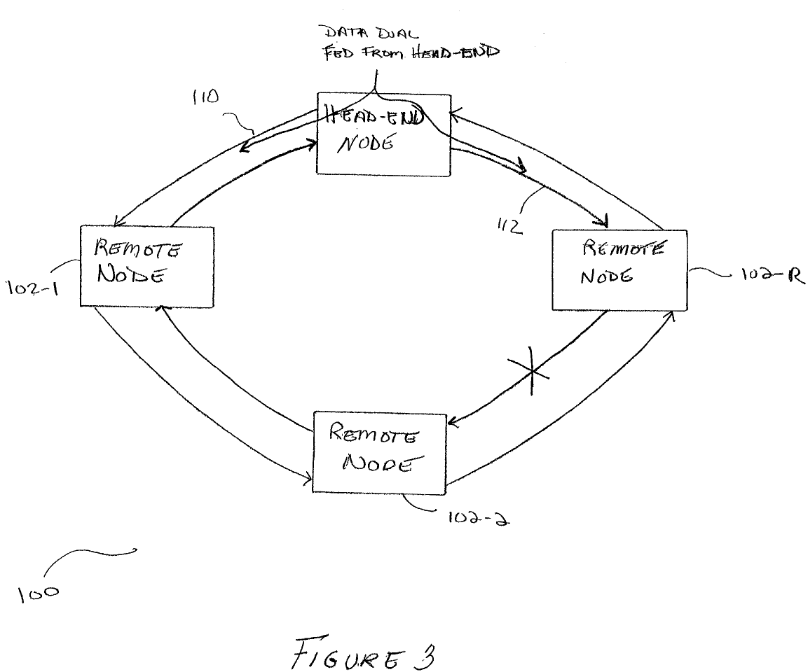

In another example, a failure occurs on the facility between remote nodes 1022 and 102-R that affects only transmission ring 112 as shown in FIG. 3. In this example, remote node 102-2 detects the failure on transmission ring 112 and inserts forward alarm signals on transmission ring 112 and return alarm signals on transmission ring 110. In one embodiment, remote node 102-2 detects the failure on transmission ring 112 by detecting or receiving ring level alarm signals. Based on the failure detected on transmission ring 112, remote node 102-2 selects transmission ring 110 to receive traffic from head end node 104 and transmission ring 112 to transmit traffic on. Remote node 102-1 receives forward alarm signal(s) from remote node 102-2 on transmission ring 112 and forwards it on transmission ring 112. Based on the received forward alarm signals, remote node 102-1 selects transmission ring 110 to receive traffic from head end node 104 and transmission ring 112 to transmit traffic.

Remote node 102-R receives return alarm signal(s) from remote node 102-2 on transmission ring 110 and forwards it on transmission ring 110. Based on the received return alarm signals, remote node 102-R selects transmission ring 110 to transmit traffic. Remote node 102-R selects either transmission ring 110 or 112 to receive traffic from head end node 104. Each remote node 102-1 to 102-R that receives forward or return alarm signals forwards the signal(s) along the transmission path 110 and/or 112 that it was received on. Once the alarm signals reach head end node 104 they are terminated.

In another embodiment, remote nodes 102-1 to 102-R determine which transmission lines 110, 112 to transmit and receive traffic on based on forward and return alarm signals as well as alarm, failure and/or error signals, transmission parameters and the like. In one embodiment, the forward and return alarm signals are implemented as standard ATM level OAM cells on a single ATM connection between the head end node 104 and each remote node 102-1 to 102-R. In an alternate embodiment, the forward and return alarm signals are SONET/SDH level signals carried over the DCC or user defined overhead bytes.

In one embodiment, any remote node 102-1 to 102-R detecting a ring level alarm or forward alarm signal selects the ring with the alarm signal to transmit to head end node 104 and the other ring to drop traffic from head end node 104. In another embodiment, any remote node 102-1 to 102-R detecting a ring level alarm or forward alarm signal selects the ring with the alarm signal to transmit to head end node 104 and either ring to receive traffic on. In one embodiment, any remote node 102-1 to 102-R receiving a return alarm signal selects the ring with the return alarm signal to transmit to, as well as receive traffic from head end node 104. In another embodiment, any remote node 102-1 to 102-R receiving a return alarm signal selects the ring with the return alarm signal to transmit traffic on and either ring to receive traffic on.

Due to their simplicity embodiments of the current invention reduce development time for dual-fed networks, as there is minimum hardware/software required to perform the dual feeding and summing at head end node 104 as well as switching at remote nodes 102-1 to 102-R. In addition, embodiments of the current invention provide a compromise between dual-fed ring networks and non-dual fed ring networks. Current schemes based on dual-feeding ATM cells at a head-end node (source), generally provide the fastest switching time since no rerouting of data is required. However such schemes require double the ATM processing capability to monitor for ATM alarms on the dual-fed connections. Schemes that are do not dual feed ATM cells at the source, but rather use a protocol (e.g. as In 1:n Automatic Protection Switching) to enable the remote nodes to signal the source to reroute the traffic are generally slower, but do not require double the bandwidth or processing capability. In contrast, embodiments of the current invention have an increased switching time over non dual-fed schemes and don't require double the bandwidth or processing capability needed for other dual-fed schemes.

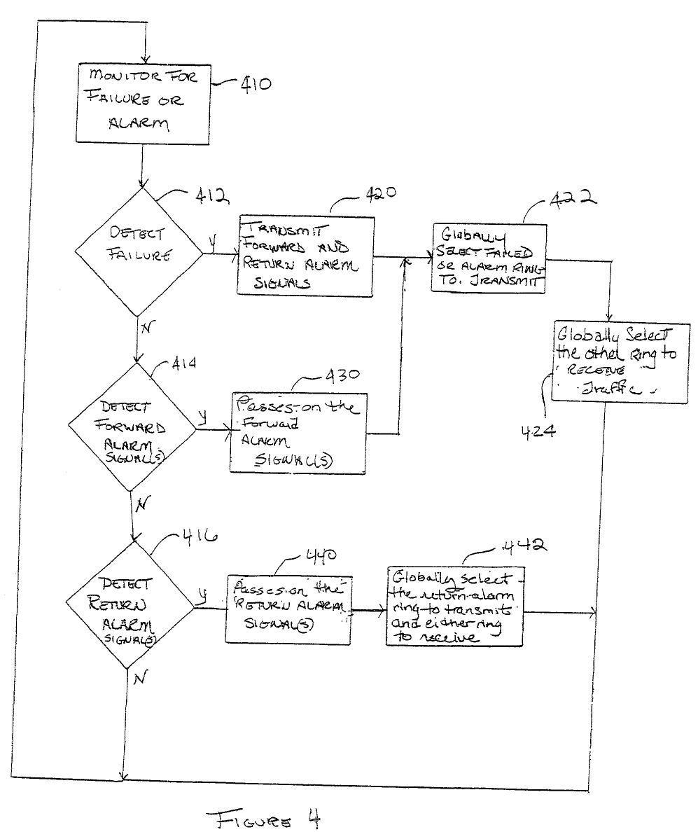

FIG. 4 is a flow chart that illustrates an embodiment of a process for remote units 102-1 to 102-R to select between transmission rings 110 and 112 according to the teachings of the present invention. The process is performed at each remote node 102-1 to 102-R. The method begins at 410 and monitors the network for failure or alarm signals. At block 412, the method determines whether a failure has been detected. If not, the method proceeds to block 414. If however, the method determines that a failure exists, the method proceeds to block 420. At block 420, the method transmits forward and return alarm signals. The method proceeds to block 422 and globally selects the ring on which a failure is detected to transmit traffic to the head-end node 104. The method then proceeds to block 424 and globally selects the other ring to receive signals. The method returns to block 410. In one embodiment, the method proceeds to block 424 and globally selects either ring to receive signals.

At block 414, the method determines whether any forward alarm signals exist. If not, the method proceeds to block 416. If however, the method detects a forward alarm signal, the method proceeds to block 430 and passes on the detected forward alarm signal on the same transmission ring on which the forward alarm signal was detected. The method proceeds to block 422 and operates as discussed above.

At block 416, the method determines whether any return alarm signals exist. If not, the method returns to block 410. If however, the method determines that return alarm signal exists, the method proceeds to block 440. At block 440, the method passes on the detected return alarm signal on the same transmission ring on which the return alarm signal was detected. The method proceeds to block 442 and globally selects the transmission ring on which the return alarm was detected (return alarm ring) to transmit to head-end node 104 and either ring to receive traffic from head-end node 104. The method then returns to block 410.

### Conclusion

Although specific embodiments have been illustrated and described herein, it will be appreciated by those of ordinary skill in the art that any arrangement, which is calculated to achieve the same purpose, may be substituted for the specific embodiments shown. For example the head end node may be is any one of a number of access network equipment elements such as, an ADSL transmission unit-central office, a central office DSLAM, an integrated DLC, a remote DSLAM that is subtended from a DSLAM or an ATM switch, a remote access multiplexer subtended from a DSLAM or an ATM switch, or the like. This application is intended to cover any adaptations or variations of the present invention. Therefore, it is intended that this invention be limited only by the claims and the equivalents thereof.

A method of ring protection switching in a network having a first and a second transmission ring. The method includes transmitting traffic to a plurality of remote nodes via the first and second transmission rings and globally selecting the first and second transmission rings to transmit and receive traffic based on alarm signals generated in the network.

A method of ring protection has been described. The method includes feeding traffic on two transmission rings at a head end node and summing all traffic received on the transmission rings at the head end node. When a facility failure is detected, by a remote node, on one of the two transmission rings, transmitting forward alarm signals on the one transmission ring and return alarm signals on the other transmission ring and globally selecting the one transmission ring to transmit traffic and the other transmission ring to receive traffic from the head end node. When a remote node receives a forward alarm signal, the remote node passes the forward alarm signal on the transmission ring on which the forward alarm signal was received and globally selects the transmission ring on which the forward alarm signal was received to transmit traffic and the other transmission ring to receive traffic from the head end node.

What is claimed is:

1. A method of protection in a network having a first and a second transmission ring, the method comprising:
transmitting traffic to a plurality of remote nodes via the first and second transmission rings; and
globally selecting the first and second transmission rings to transmit and receive traffic based on alarm signals generated in the network.

2. The method of claim 1, further comprising:
summing all traffic received from the plurality of remote nodes.

3. A method of ring protection, comprising:
at a head end node:
feeding traffic on two transmission rings; and
summing all traffic received on the two transmission rings; at remote nodes:
when a remote node detects a facility failure on one of the two transmission rings,
transmitting forward alarm signals on the one transmission ring and return alarm signals on the other transmission ring; and
globally selecting the one transmission ring to transmit traffic and the other transmission ring to receive traffic from the head end node; and when a remote node receives a forward alarm signal,
passing the forward alarm signal on the transmission ring on which the forward alarm signal was received; and
globally selecting the transmission ring on which the forward alarm signal was received to transmit traffic and the other transmission ring to receive traffic from the head end node.

4. The method of claim 3, further comprising:
when a remote node receives a return alarm signal,
passing the return alarm signal on the transmission ring on which the return alarm signal was received; and
globally selecting the transmission ring on which the return alarm signal was received to transmit traffic to the head end node and one of the two transmission rings to receive traffic from the head end node.

5. The method of claim 3, wherein when a remote node detects a facility failure on one of the two transmission rings comprises when a remote node receives a ring level failure alarm on one of the two transmission rings.

6. The method of claim 3, further comprising:
at the head end node,
terminating received forward and return alarm signals.

7. A method of ring protection at a remote node in a dual fed network, comprising:
detecting a facility failure on a first transmission ring;
transmitting a forward alarm signal on the first transmission ring and transmitting a return alarm signal on a second transmission ring;
globally selecting the first transmission ring to transmit traffic to a head end node; and
globally selecting the second transmission ring to receive traffic from the head end node.

8. The method of claim 7, further comprising:
wherein the head end node sums traffic from the first and second transmission rings.

9. The method of claim 7, further comprising:
wherein, the head end node terminates received forward and return alarm signals.

10. The method of claim 7, wherein detecting a facility failure on a first transmission ring comprises receiving a ring level failure alarm on a first transmission ring.

11. A method of ring protection at a remote node in a dual fed network, comprising:
detecting a forward alarm signal on a first transmission ring;
passing the forward alarm signal on the first transmission ring;
globally selecting the first transmission ring to transmit traffic to a head end node; and
globally selecting the second transmission ring to receive traffic from the head end node.

12. The method of claim 11, further comprising:
wherein the head end node sums traffic from the first and second transmission rings.

13. The method of claim 11, further comprising:
wherein, the head end node terminates received forward alarm signals.

14. A method of ring protection at a remote node in an access network having a head end node that dual feeds traffic on a first and a second transmission ring to a plurality of remote nodes, the method comprising:
when one of the plurality of remote nodes receives a return alarm signal,
passing the return alarm signal on the transmission ring on which the return alarm signal was received; and
globally selecting the transmission ring on which the return alarm signal was received to transmit traffic to the head end node and one of the first or second transmission rings to receive traffic from the head end node.

15. A method of ring protection at a remote node in an access network having a head end node that dual feeds traffic on a first and a second transmission ring to a plurality of remote nodes, the method comprising:
when the remote node receives a forward alarm signal,
passing the forward alarm signal on the transmission ring on which the forward alarm signal was received; and
globally selecting the transmission ring on which the forward alarm signal was received to transmit traffic to the head end node and the other transmission ring to receive traffic from the head end node.

16. A method of ring protection in an asynchronous transfer mode (ATM) synchronous optical ring network, the method comprising:
at a central unit:
feeding traffic on two transmission rings; and
summing all traffic received on the two transmission rings;
at a plurality of remote units:
when one of the plurality of remote units detects a facility failure on one of the two transmission rings,
transmitting forward alarm signals on the one of the two transmission rings and return alarm signals on the other of the two transmission rings, wherein the forward and return alarm signals are ATM level operations, administration and maintenance cells; and
globally selecting the one of the two transmission rings to transmit traffic and the other of the two transmission rings to receive traffic from the central unit; and when one of the plurality of remote units receives a forward alarm signal,
passing the forward alarm signal on the one of the two transmission rings on which the forward alarm signal was received; and
globally selecting the one of the two transmission rings on which the forward alarm signal was received to transmit traffic and the other of
the two transmission rings to receive traffic from the central unit.

17. The method of claim 16, further comprising:
when one of the plurality of remote units receives a return alarm signal,
passing the return alarm signal on the one of the two transmission rings on which the return alarm signal was received; and
globally selecting the one of the two transmission rings on which the return alarm signal was received to transmit traffic to the central unit and one of the two transmission rings to receive traffic from the central unit.

18. The method of claim 16, wherein when one of the plurality of remote units detects a facility failure on one of the two transmission rings comprises when one of the plurality of remote units receives a ring level failure alarm on one of the two transmission rings.

19. The method of claim 16, further comprising:
at the central unit,
terminating received forward and return alarm signals.

20. A method of ring protection in a network having a central unit and a plurality of remote units, comprising:
at the central unit:
dual feeding traffic along a first and a second transmission ring to the plurality of remote units; and
combining traffic received on the first and second transmission rings; and
at the remote units:
detecting a facility failure on the first transmission ring;
transmitting a forward alarm signal on the first transmission ring;
transmitting a return alarm signal on the second transmission ring;
globally selecting the first transmission ring to transmit traffic;
globally selecting the second transmission ring to receive traffic;
when a forward alarm signal is received, globally selecting the one of the first or second transmission rings carrying the forward alarm signal to transmit traffic and the other ring to receive traffic; and
when a return alarm signal is received, globally selecting the one of the first or second transmission rings carrying the return alarm signal to transmit traffic and one of the first or second transmission rings to receive traffic.

21. The method of claim 20, wherein detecting a facility failure on the first transmission ring comprises receiving a ring level alarm signal on the first transmission ring.

22. The method of claim 20, further comprising:
at the central unit,
terminating received forward and return alarm signals.

23. A ring network, comprising:
a headend node;
a plurality of network nodes;
wherein the headend node and the plurality of network nodes are interconnected via a number of ring segments which form a first and a second transmission ring, wherein the headend node dual feeds data to the plurality of network nodes on the first and second transmission rings;
wherein when a failure is detected in one of the ring segments, adjacent ones of the plurality network nodes transmit forward and return alarm signals;
wherein when a failure is detected or an alarm signal is received by one of the plurality of network nodes the receiving network node selects one of the first and second transmission rings carrying the failure data or forward alarm signal to transmit traffic and the other ring to receive traffic; and
wherein when a return alarm signal is received by one of the plurality of network nodes, the receiving network node selects the one of the first and second transmission rings carrying the return alarm signal to transmit traffic and selects one of the first or second transmission rings to receive traffic.

24. The network of claim 23, wherein alarm signals are terminated at the headend node.

25. A ring network, comprising:
a headend node;
a plurality of network nodes;
wherein the headend node and the plurality of network nodes are interconnected via a number of ring segments which form a first and a second transmission ring, wherein the headend node dual feeds data to the plurality of network nodes on the first and second transmission rings;
wherein when a facility failure is detected on the first transmission ring, adjacent network nodes transmit forward alarm signals on the first transmission ring and return alarm signals on the second transmission ring;
wherein when a failure is detected or a forward alarm signal is received by one of the plurality of network nodes the one network node selects the transmission ring carrying the failure or forward alarm signal to transmit traffic and the other ring to receive traffic; and
wherein when a return alarm signal is received by one of the plurality of network nodes, the receiving network node selects the ring carrying the return alarm signal to transmit traffic and one of the first or second transmission rings to receive traffic.

26. The network of claim 25, wherein the headend node terminates received alarm signals.

27. A ring network, comprising:
a plurality of network elements including a central unit and a number of remote units;
a plurality of ring segments coupled between adjacent network elements to form first and second transmission rings, wherein the central unit transmits data on the first transmission ring in the a first direction and transmits the same data on the second transmission ring in a second direction;
wherein when a failure is detected on one of the first or second transmission rings, adjacent network elements transmit a forward alarm signal on the transmission ring on which the failure was detected and a return alarm signal on the other transmission ring;
wherein when a failure is detected or a forward alarm signal is received by one of the number of remote units, the receiving remote unit selects the ring carrying the failure data or alarm signal to transmit traffic and selects the other ring to receive traffic; and
wherein when a return alarm signal is received by one of the number of remote units, the receiving remote unit selects the ring carrying the defect signal to transmit traffic and one of the first or second transmission rings to receive traffic.

28. The network of claim 27, wherein alarm signals are terminated at the central unit.

29. A ring network, comprising:
a plurality of network elements including a central unit and a number of remote units;
a plurality of ring segments coupled between adjacent network elements to form first and second transmission rings, wherein the central unit transmits data on the first transmission ring in the clockwise direction and transmits the same data on the second transmission ring in the counter clockwise direction;
wherein when a failure is detected on both of the first and second transmission rings, adjacent network elements transmit a forward alarm signal on the transmission ring on which the network element detected a failure and a return alarm signal on the other transmission ring; and
wherein when a failure is detected or a forward alarm signal is received by one of the number of remote units, the receiving remote unit selects the ring carrying the failure data or alarm signal to transmit traffic and selects the other ring to receive traffic.

30. The network of claim 29, wherein alarm signals are terminated at the central unit.

31. A method of ring protection at a remote node in an access network having a head end node that dual feeds traffic on a first and a second transmission ring to a plurality of remote nodes, the method comprising:
when one of the plurality of remote nodes receives a return alarm signal,
passing the return alarm signal on the transmission ring on which the return alarm signal was received;
globally selecting the transmission ring on which the return alarm signal was received to transmit traffic to the head end node; and
arbitrarily selecting one of the first or second transmission rings to receive traffic from the head end node.
